(19) United States
(12) Patent Application Publication
(10) Pub. No.: US 2026/0122063 A1
(43) Pub. Date: Apr. 30, 2026

(54) METHOD FOR SECURELY ACQUIRING A BIOMETRIC FEATURE

(71) Applicant: IDEMIA PUBLIC SECURITY FRANCE, Courbevoie (FR)

(72) Inventor: Fabien MICAELLI, Courbevoie (FR)

(73) Assignee: IDEMIA PUBLIC SECURITY FRANCE, Courbevoie (FR)

(21) Appl. No.: 19/236,660

(22) Filed: Jun. 12, 2025

(30) Foreign Application Priority Data
Oct. 31, 2024 (FR) FR2411937

(51) Int. Cl. H04L 9/40; H04L 9/08

(52) U.S. Cl. CPC H04L 63/0861; H04L 9/0866

(57) ABSTRACT

A method for securely acquiring a biometric feature, the method including determining a first set of characteristic values defining a first set of luminous events for which at least one characteristic value per event is determined by random selection, controlling the intensity of at least one lighting source so as to apply the first set of events during a first biometric acquisition, carrying out the first biometric acquisition by linearly exposing the acquisition surface over a predetermined dimension for a predetermined exposure time, emitted in the form of an acquisition matrix, characterizing a first observed lighting pattern, evaluating a matching index based on the first observed pattern and the first prescribed pattern, and judging the presence or absence of fraud by comparing the matching index with a matching threshold.

### TECHNOLOGICAL BACKGROUND

The present invention relates to the field of security for biometric acquisition terminals. Indeed, biometric data is secured within a terminal and during exchanges with a server managing a group of terminals, but the flow of images travelling over a dedicated network between the contact-based optical biometric feature acquisition device and the embedded processor of the terminal also needs to be secured, in order to protect against listening and/or replaying by a fraudster seeking to usurp the identity of a legitimate user by mimicking the signal travelling over the network by injecting a signal emulating a previous biometric acquisition of the legitimate user (known as an “injection attack”).

### DESCRIPTION OF THE INVENTION

The aim of the invention is to at least partly overcome some of these disadvantages, and preferably all of them, and it notably aims to propose a method for securely acquiring a biometric feature that is able to counter injection fraud, is easy to implement on existing terminals and is accessible to all, without significantly affecting the authentication or enrolment times, including the acquisition time.

According to one aspect of the invention, a method is proposed for secure contact-based acquisition of a biometric feature of a user, comprising the steps of:
determining a first set of characteristic values defining a first set of luminous events to be applied to an acquisition surface for the biometric feature, said first set of events describing a first lighting temporal sequence depicted as a matrix in the form of a first prescribed lighting pattern, said values characterizing, for each event of the first set, a lighting type for the acquisition surface and an application instant for said event, with at least one characteristic value per event, from among the application instant and the lighting type, being determined by random selection;
controlling the intensity of at least one lighting source, emitting in a first wavelength, so as to apply the first set of events during a first biometric acquisition;
carrying out a first biometric acquisition by linearly exposing the acquisition surface over a predetermined dimension for a predetermined exposure time, emitted in the form of an acquisition matrix;
characterizing, based on the acquisition matrix of the first biometric acquisition, a first observed lighting pattern;
evaluating a matching index based on the first observed pattern and the first prescribed pattern; and
judging the presence or absence of fraud by comparing the matching index with a matching threshold in order to continue the method with a biometric enrolment step or a biometric authentication step if the matching threshold is met.

This method allows a luminous trial to be added during biometric acquisition, with the trial being random in terms of its lighting type and/or application instant, and its verification being implemented by analysing the pattern observed in the acquired image by linearly exposing the acquisition surface in the direction of the predetermined dimension. Thus, if the observed pattern does not match the prescribed pattern, i.e., the matching index is strictly below a matching threshold, the method is interrupted, preventing enrolment or authentication based on the acquired image, and a warning can be issued. This method therefore addresses the aforementioned disadvantages and is preferably applied from a contact-based biometric feature acquisition terminal within a biometric access control system. It thus allows the acquisition to be equally secured within an enrolment context (for example, for creating an access account) or within an authentication context (for example, for accessing a given area, a building or a real or virtual space, or a service). Indeed, the random nature (including the pseudo-random nature) of the emitted luminous signal constitutes a trial and is used to verify that the image acquired at the acquisition instant by the optical acquisition device of the terminal actually originates from the terminal at said instant and not from a third-party object, notably by means of a recording of an image acquired by the terminal at a time other than said acquisition instant. Furthermore, this method allows fraud to be prevented and secures the communication bus between an optical acquisition device and a data processing device without having to extract the application instants of events as such from the acquired images.

Equivalently, a non-matching index can be determined and, in this case, the threshold condition authorising the continuation of the method applies if the non-matching index is below a non-matching threshold.

Preferably, the intensity control applying the first set of events in the lighting temporal sequence involves at least one switching on and/or at least one switching off phase, notably per channel.

According to advantageous and non-limiting features:
said evaluation of a matching index involves comparing the first observed pattern with the first prescribed pattern, with the matching index depending on a ratio between the first observed pattern and the first prescribed pattern.
Said method further comprises the steps of:
   determining a second set of characteristic values defining a second set of luminous events to be applied to the acquisition surface, said second set of events describing a second lighting temporal sequence depicted as a matrix in the form of a second prescribed lighting pattern, said values characterizing, for each event of the second set, a lighting type for the acquisition surface and an application instant for said event, with at least one characteristic value per event, from among the application instant and the lighting type, being determined by random selection;
   controlling the intensity of the lighting source so as to apply the second set of events during a second biometric acquisition step;
   carrying out a second biometric acquisition by linearly exposing the acquisition surface over the predetermined dimension for a predetermined exposure time that is equal to or different from the predetermined exposure time, emitted in the form of an acquisition matrix;
   characterizing, based on the acquisition matrix of the second biometric acquisition, a second observed lighting pattern;
   evaluating the matching index based on the second observed pattern and the second prescribed pattern.
Said at least one characteristic value per event determined by random selection for the same terminal and/or user is stored in an exclusion register in conjunction with an identifier of said terminal and/or a user biometric identifier to which they have been applied, which prevents them from being applied twice, at least for a given time period, to the same terminal and/or user.
Evaluating a matching index involves comparing observed patterns with the prescribed patterns, with the matching index depending on a ratio between the first observed pattern and the second observed pattern, divided by a ratio between the first prescribed pattern and the second prescribed pattern.
The method according to the invention comprises a step of reconstructing an image of the biometric feature from the first and second acquisition matrices, notably by merging based on said acquisition matrices, which allows the images acquired for the biometric authentication to be used without having to acquire new ones.
Biometric authentication or enrolment comprises:
   constructing a biometric template.
Biometric authentication comprises a biometric recognition (matching) step based on the at least one acquisition matrix of the at least one biometric acquisition and in relation to enrolled biometric data.
The method comprises an initialisation step triggered by detecting the presence of an object, such as a finger or a palm of an individual, in contact with the acquisition surface.
The method according to the invention is implemented by a computer, notably by a central processing unit of a contact-based biometric feature acquisition terminal.
The biometric feature is a finger or palm dermatoglyph.
The value characterizing the event application instant designates a row of the prescribed lighting pattern depicted as a matrix.
The value of the lighting type designates a prescribed lighting state, or a modification of lighting, for example, from among a modulation of the intensity of the lighting by the lighting source, the switching off of the lighting source or the switching on of the lighting source, which allows events to be created by altering lighting.
The lighting type also refers to the lighting source, which allows several lighting sources to be distinguished, notably those with different wavelengths, thus complicating the trial.
Each set of events comprises at least two events, which makes the trial more complicated.
Said application instants of each event of the first or second acquisition are defined relative to the start of exposure, specific to said acquisition, of the first row in the predetermined dimension of the acquisition matrix; this allows the lighting events to be synchronized relative to the start of exposure of each acquisition, and then allows the rows affected by the events in the prescribed pattern to be easily computed, in order to be able to compare them with those of the observed pattern.
The value of the lighting type designates the prescribed lighting state, with said application instants of each event of the first or second acquisition characterizing the start instant of the application of the prescribed lighting state specific to said event.
At least one of the sets of determined characteristic values contains, for at least one of the events, a value characterizing the end of the application of the prescribed lighting state specific to said event. Advantageously, said value characterizing the end of application of the prescribed lighting state specific to said event is an application duration. As a variant, said value characterizing the end of application of the prescribed lighting state specific to said event is an end of application instant.
The application duration is greater than one third of an acquisition period.
Each prescribed pattern is expressed as a theoretical average brightness of each row of its acquisition matrix, with each prescribed pattern being determined based on its characterizing lighting temporal sequence and on the predetermined exposure time of the acquisition matrix.
Characterizing the observed pattern is carried out, for each biometric acquisition, by:
   computing an average brightness per channel, notably monochrome, red, green or blue, of each row of the acquisition matrix in the predetermined dimension.
   The step of evaluating the matching index involves computing a ratio of the patterns observed row-by-row, notably in the form of a vector, between the average brightness of each row of the acquisition matrix of the second acquisition and the average brightness of each line of the acquisition matrix of the first acquisition, and a ratio of the prescribed patterns row-by-row, notably in the form of a vector, between the theoretical brightness of each row of the second prescribed pattern and the average theoretical brightness of each row of the first prescribed pattern.
   According to another aspect, a biometric access control system is proposed comprising:
a terminal for contact-based acquisition of a biometric feature, said terminal comprising:
a contact-based optical acquisition device comprising a sensor, an acquisition surface configured to be in contact with the biometric feature, and a rolling shutter configured to linearly expose the acquisition surface over a predetermined dimension for a predetermined exposure time, with said optical acquisition device being configured to transmit a signal representing the acquired biometric feature in the form of an acquisition matrix;
   a lighting source emitting in a first wavelength and disposed behind the acquisition surface and emitting towards the acquisition surface;
   an intensity control device for at least one lighting source emitting in a first wavelength so as to apply the first set of events during a first biometric acquisition step;
   a communication bus between the optical acquisition device and a data processing device;
the data processing device comprising:
   a module for determining a first set of characteristic values defining a first set of luminous events to be applied to an acquisition surface for the biometric feature, said first set of events describing a first lighting temporal sequence depicted as a matrix in the form of a first prescribed lighting pattern, said values characterizing, for each event of the first set, a lighting type for the acquisition surface and an application instant for said event, with at least one characteristic value per event, from among the application instant and the lighting type, being determined by random selection;
   a module for characterizing an observed lighting pattern of said acquisition matrix;
   a module for evaluating a matching index based on the observed pattern and the prescribed pattern and for judging the presence or absence of fraud.

Said system has the same advantages as the method according to the invention.

Advantageously, the sensor is a total reflection sensor.

Advantageously, the sensor is a monochrome or multichannel (RGB) sensor.

Advantageously, the data processing device comprises a local central processing unit on the terminal controlling the control device and comprising a high-precision internal clock.

Advantageously, the data processing device comprises a random number generator.

Advantageously, the biometric access control system implements the method according to the invention.

Advantageously, the terminal comprises another lighting source emitting in another wavelength, with each set of characteristic values comprising, per event, a value designating the lighting source from among the lighting sources of the terminal, which allows more complex multi-coloured trials to be formed.

In one embodiment, the data processing device includes:
a memory, storing enrolled biometric data, notably in the form of a template;
   a biometric recognition module based on the first biometric acquisition or on a reconstructed image of the biometric feature and the enrolled biometric data.

Advantageously, said system comprises a module for at least partially reconstructing an image of the biometric feature, which allows, in the case of multiple biometric acquisitions, a complete, quality image of the biometric feature to be reconstructed, notably by merging.

According to another aspect of the invention, a computer program is proposed comprising instructions adapted to implement each of the steps of the method according to the invention when said program is executed on a computer.

According to another aspect of the invention, a non-transient, removable or non-removable information storage medium is proposed that can be partially or totally read by a computer or a microprocessor, comprising code instructions of a computer program for executing each of the steps of the method according to the invention.

### DESCRIPTION OF THE FIGURES

The invention will be better understood with reference to the following description, which relates to embodiments and variants of the present invention, which are provided by way of non-limiting examples and are explained with reference to the accompanying schematic drawings, in which:

FIG. 1 illustrates a person approaching their finger towards a biometric acquisition terminal according to one possible embodiment of the invention;

FIG. 2 shows a schematic diagram of the steps implemented in the security method according to one possible embodiment of the invention;

FIG. 3 illustrates a schematic diagram according to one embodiment of the security method;

FIG. 4 illustrates an example of the structure of a data processing device of a system according to the invention; and

FIG. 5 shows an example of signals computed when implementing the method according to one embodiment of the invention.

Identical references will be used from one figure to another to designate elements that are identical or similar in form or function.

For the sake of brevity, the term “substantially” refers to values within plus or minus 10 %.

### DETAILED DESCRIPTION

The invention can be applied in various enrolment or authentication contexts with a view to access by means of a contact-based biometric feature acquisition terminal.

The method according to the invention can be used in various applications for detecting injection fraud during enrolment or authentication, with the fraud detection being based on an evaluation of a matching index depending on the pattern observed on the acquired biometric image and the prescribed lighting pattern of the acquisition surface, with the prescribed pattern depending on a random selection.

The invention can be used in the case of a user accessing a vehicle or a restricted area, notably, a building or a space, such as a port, for example.

For the sake of simplicity and by way of a non-limiting illustration, the invention will be described hereafter within the context of a biometric method for authenticating a dermatoglyph, but the teaching can be used for any application involving the authentication of a venous network. Similarly, in the illustrated embodiment, the dermatoglyph is a finger dermatoglyph, but in a variant, the dermatoglyph can be a palm dermatoglyph.

The term random selection refers to the random or pseudo-random drawing of numbers.

The term authentication refers to one-to-one or one-to-n authentication, also called identification.

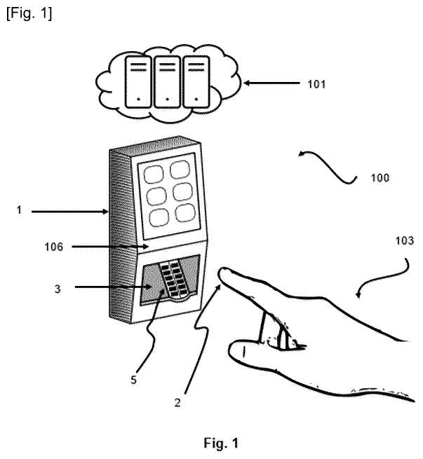

With reference to FIG. 1, the authentication method can be implemented by means of a biometric access control system 100 comprising a contact-based biometric acquisition terminal 1, with a user 103 presenting their finger thereto in order to apply their finger dermatoglyph (papillary print). The biometric acquisition terminal 1 comprises a sensor provided with a rolling shutter and a lighting source 5, disposed behind the acquisition surface 3 so as to illuminate it, with said acquisition surface 3 being configured to be in contact with the dermatoglyph 2 of the user 103.

The acquisition surface 3 is, for example, all or part of the upper surface of a slide, also called prism, (notably made of a transparent material such as polymethyl methacrylate (PMMA)) forming a light propagation medium, or a TFT (Thin-Film Transistor) plate.

A lighting source 5, disposed behind the acquisition surface 3, refers, for example, to:
a lighting source disposed below the acquisition surface 3 and emitting directly towards the acquisition surface; or
a lighting source disposed laterally below the acquisition surface 3 and provided with a diffuser below the acquisition surface 3 for guiding the luminous emission along this optical path towards the acquisition surface.

During a biometric acquisition, the rolling shutter linearly exposes the acquisition surface 3 over a predetermined dimension, preferably vertically: line-by-line, for a predetermined exposure duration, with the biometric acquisition being carried out by the optical acquisition device and being emitted in the form of an acquisition matrix.

The lighting source 5 comprises, for example, red light-emitting diodes (LEDs).

The sensor, for example, a total reflection sensor, is disposed so as to receive the light diffused by the finger placed on the acquisition surface, and its acquisition field covers all or part of the acquisition surface. The light emitted by the lighting source 5 travels through an optical path between the acquisition surface 3 and the sensor. The sensor is, for example, located behind the acquisition surface 3 and notably can be positioned offset from the acquisition surface (CMOS sensor, for example), or can be, for example, combined with the acquisition surface 3 (sensor in the form of a TFT plate, for example). As a variant, the rolling shutter could expose horizontally: column-by-column.

A printed circuit board (PCB) (not shown) is disposed, for example, behind the sensor and is connected to the on-board data processing device 106 of the terminal 1 by a network (not shown). As a variant, the sensor could be soldered onto the same printed circuit board as the central processing unit (CPU) of the data processing device 106.

Each image acquired by the optical acquisition device and, more specifically, by the sensor, is conveyed, either raw or after conversion, via a bus on the network when it is sent to the on-board data processing device 106 of the biometric acquisition terminal 1. This therefore notably involves securing the biometric information passing through this network by monitoring it in order to prevent the fraudulent disconnection of the bus and notably to prevent injection fraud, which would involve an attacker listening to biometric data and then replaying it at a later time. The biometric acquisition terminal comprises an information processing device 106 capable of implementing all or some of the steps of the method according to the invention. In the illustrated embodiment, the biometric access control system 100 comprises a remote data processing device 101, such as a server, and the data passing between the biometric acquisition terminal 1 and the remote device 101 is preferably conveyed in encrypted form, notably over an Ethernet network or even over the Internet. Preferably, the remote device 101 is used to carry out the biometric tasks of comparing biometric templates when authenticating the biometric feature.

The biometric acquisition terminal 1 can be a mobile authentication terminal, such as a mobile identity check terminal in an airport, or a mobile identity check terminal in a polling station, or a fixed terminal, such as a fixed terminal dedicated to identity checks at borders, for example. The biometric acquisition terminal 1 also can be an electronic sub-system installed in a vehicle forming a connected driver recognition system or providing access to applications for the driver or the passenger. The biometric access control system 100 can comprise multiple terminals 1.

The data processing device 106 comprises at least one processor and a memory, and allows a computer program to be executed for implementing the method according to the invention.

When the user 103 wishes to identify themselves on the biometric acquisition terminal 1 in order to access a service or a restricted access area, they first submit an identification request to said biometric acquisition terminal 1, for example, simply by placing their finger on the acquisition surface 3 of the contact sensor. In another example, the request can be submitted using a human-machine interface (HMI) that may be installed on the biometric acquisition terminal 1.

Once the request has been submitted, the biometric acquisition terminal 1 acquires a biometric feature of the user 103 by applying the security method according to the invention so as to notably detect the occurrence of injection fraud and interrupt the authentication if fraud is detected. The biometric feature is selected from among at least a finger dermatoglyph, a palm dermatoglyph, a finger venous pattern, or a combination thereof. Advantageously, whether in the event of authorization to continue (no fraud) or to interrupt (fraud detected) the authentication method, this status is time-stamped and recorded in a local register or in a remote register of the biometric access control system 100. Advantageously, this register is monitored so that if the number of failed attempts for the same biometric identifier over a given time exceeds a predetermined failure threshold, then a system warning is generated so as to be sent to an agent responsible for managing all or part of the biometric access control system.

If no fraud is detected, the biometric authentication process continues and the biometric acquisition is sent to the remote data processing device 101. As a variant, the steps of the security method according to the invention can include steps implemented on the remote device 101, and the biometric acquisition has already been sent to said remote device 101 before judging the presence or absence of fraud. The biometric acquisition received by the remote device 101 then constitutes the authentication test (resulting from prior enrolment), notably in the form of a biometric test template according to an encoding scheme. The remote device 101 then compares the authentication test with one (one-to-one authentication) or more (one-to-n authentication) reference biometric templates stored in a biometric template database. As a variant, the authentication steps can be carried out on the biometric acquisition terminal 1 without requiring a remote server, notably in the case of a limited biometric template database or in the case of multi-factor authentication, which allows one-to-one authentication to be carried out, preferably locally in the case, for example, of a multi-factor terminal 1 comprising a smart card reader, with the chip of the card encoding the biometric feature of the cardholder, i.e., their reference biometric template, or an access key to this reference biometric template in the memory of the biometric acquisition terminal 1.

If there is a match between the authentication test and at least one authorized biometric template in the biometric template database, or in the case of one-to-one authentication between the authentication test and the biometric template, the user 103 is authenticated. They are then authorized to access the service or the restricted access area. Otherwise, the user 103 is not authenticated and access is denied. The biometric access control system 100 can notify the user 103 of the authentication status, namely, whether the authentication was successful or failed, by means of a luminous signal, an audible signal, a message, or a combination thereof. In both cases, the authentication status is time-stamped and supplements the status already recorded in the local register or in the external register.

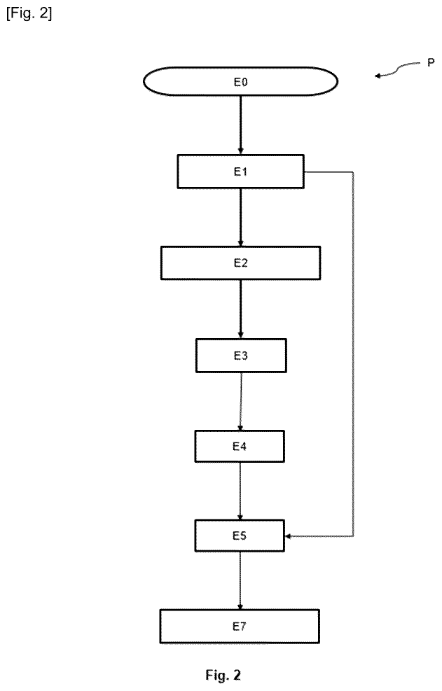

With reference to FIG. 2, the method according to the invention is described in the form of a flowchart showing the steps implemented in the security method, according to one possible embodiment of the invention. The user 103 submits an identification request to said biometric acquisition terminal 1 by placing their finger on the acquisition surface 3, i.e., by presence detection. A biometric authentication method is then initiated and calls upon the security method P according to the invention to detect injection fraud attempts and, in the event of such fraud, to prevent the authentication from continuing and thus prevent access.

The initialisation step E0 of the security method P corresponds to the reception, notably by the information processing device 106 of the terminal 1, of said request, and in particular of an image acquired without lighting during this presence detection phase. Thus, any variations in acquisition conditions according to the method P are only applied when a finger is detected on the sensor, so as not to impair the user with an erratic visual aspect and to reduce the power consumption of the terminal 1. Furthermore, by considering the finger to be stationary on the acquisition surface 3, a variation in lighting between two acquisitions allows an estimate to be provided, for each row (in this case line) of the acquisition matrix, of the brightness multiplier coefficient between the two acquisitions, since the two acquired signals are identical apart from differences in lighting. In this embodiment, the initialisation step E0 involves estimating, with the lighting off, the average brightness of each line MLI_ext based on the image acquired by the optical acquisition device during the presence detection phase, in order to evaluate the surrounding brightness perceived by the sensor in order to eliminate it from subsequent computations (by subtracting said image acquired without lighting from the one or more subsequent acquired images acquired with lighting) and thereby improve their accuracy by only considering the light induced by lighting one or more controlled sources. However, since said surrounding brightness is negligible, this estimation remains optional.

The security method P then continues with the implementation E1, by the information processing device 106, of the instructions for determining a first set of characteristic values defining a first set of luminous events to be applied to a dermatoglyph acquisition surface, with said first set of events describing a first lighting temporal sequence depicted as a matrix in the form of a first prescribed lighting pattern, said values characterizing, for each event of the first set, a lighting type for the acquisition surface and an application instant for said event, with at least one characteristic value per event, from among the lighting type and the application instant, being determined by random selection. The depiction of the lighting pattern as a matrix is expressed, for example, by one table per lighting source, advantageously having the same number of lines as the acquisition matrix and storing a prescribed light intensity value in each line, and this depiction then can be related to an acquisition matrix, i.e., to the signal resulting from a biometric acquisition by linearly exposing the acquisition surface over a predetermined dimension for a predetermined exposure time. The table can also include a single column since, on average, the same intensity value is applied to the entire line; in this case, a multiplication by an identity table with the same width as the acquisition matrix is applied, for example, for evaluating E5 the matching index. This embodiment also allows noise to be filtered.

In the embodiment illustrated herein, the value of the lighting type refers to a change in lighting between switching off the lighting source and switching on the lighting source, which allows events to be created by altering the lighting.

The value of the lighting type also refers to the lighting source if the terminal 1 comprises several lighting sources 5 capable of directly or indirectly illuminating the acquisition surface and emitting in various wavelengths, such as a first lighting source made up of a set of red light-emitting diodes (also called “backlight”) combined, for example, with another lighting source made up of an isolated red light-emitting diode (LED), and/or a second lighting source made up of, for example, a green light-emitting diode and/or a third lighting source made up of a blue light-emitting diode. This diversity in the nature and wavelength of the lighting sources allows the complexity of the trial to be increased so that a set of events includes at least two events (for example, switching on and off) and preferably between four and six events (notably with multiple lighting sources).

For each event, an application instant of the event is randomly drawn from a range of values, for example between 0 and the predetermined acquisition time, and/or a lighting type of the acquisition surface from a list of values, each designating the lighting modification to be applied and the associated lighting source 5, which list is advantageously dynamic, in that it depends on the current state of each lighting source 5, notably as a function of the previous event for each lighting source, so as to form feasible combinations.

Preferably, an application instant for an event is defined relative to the start of exposure, specific to the relevant acquisition, of the first row in the predetermined dimension of the acquisition matrix, which allows the lighting events to be synchronized relative to the start of exposure of each acquisition, and then allows the rows affected by the events in the prescribed pattern to be easily computed, so that they can be subsequently compared with those of the observed pattern. The value characterizing the application instant of an event therefore designates a row, in this case a line, of the prescribed lighting pattern depicted as a matrix.

As a variant, if the value of the lighting type designates a prescribed lighting state, the application instant of an event characterizes the start instant for applying the prescribed lighting state specific to said event and, advantageously, the set of determined characteristic values contains, for each event, a value characterizing the end of application of the prescribed lighting state specific to said event, in the form of a duration (as a number of rows or as time from the start of the exposure of the sensor) or an end of application instant. Similarly, the end of application instant of an event is preferably defined relative to the start of exposure, specific to the relevant acquisition, of the first row in the predetermined dimension of the acquisition matrix, the value characterizing the end of application instant of the event therefore allow a row, in this case a line, to be designated for the prescribed lighting pattern depicted as a matrix.

Therefore, the theoretical average brightness MLT of each line of the prescribed lighting pattern is computed for this first lighting temporal sequence based on the characteristics of its events. As a variant, the computation of the theoretical average brightness MLT of each line of the prescribed lighting pattern can be implemented, during the step E4 of executing, by means of a determination module of a central processing unit, in this case of the data processing device 106 inside the terminal 1, instructions for characterizing E4 an observed lighting pattern.

Whether the value of the lighting type designates a lighting modification or a prescribed lighting state, the duration between two events affecting the same lighting source or, respectively, the duration of an event, is preferably expressed as a unit of time and allows a matching computation to be carried out as a number of rows. This application duration is preferably not zero and is less than the predetermined exposure duration, which corresponds to the exposure of a number of rows of the rolling shutter, for example, between 100 and 600 lines for a 1,000 line shutter and notably equal to half the exposure duration, that is, 500 lines in the example. This notably involves better distinguishing of the contribution of lighting from noise. The application duration is notably selected according to whether or not the acquired images will be used subsequently. Indeed, if the acquired images are only used for fraud prevention purposes, the application durations can be shorter than if the acquired images are also used as a basis for the biometric authentication algorithm, in which case their quality in terms of image clarity may be required. For example, in the case of the backlight, signal interruptions averaging less than one-third of the exposure time (i.e., the time between two image acquisitions) are preferred so as not to substantially affect biometric authentication algorithms. Similarly, in the case of blue or green light-emitting diodes, lighting for at least half the exposure duration is preferred. Random selection is then restricted to pre-selected ranges.

The selection described herein is random and is notably configured so as not to reproduce the same trial for the same person, and notably on the same terminal. To this end, the randomly drawn values are recorded and time-stamped in a memory in conjunction with the identifier (preferably anonymized) of each user for whom the method has been applied, and notably the identifier of the terminal 1 where the acquisition occurred, thus creating an exclusion register for future selections, and this exclusion register is consulted during the determination step E1. Preferably, this exclusion register is hosted in the same memory as the time-stamped status register. If the exclusion register is hosted in the local memory of the data processing device 106 of the terminal 1, the user identifier alone may suffice, and if it is hosted in a memory of a remote server 101 (notably in the case of multiple terminals), the identifier of the terminal 1 is, for example, sent to the remote server as metadata during each connection to the remote server. The user identifier (preferably anonymized) is, for example, created and stored, preferably by the remote server, by encrypting a biometric template of the dermatoglyph acquired based on the images acquired in step E2. Thus, for the next random draw for the same terminal, the selection will exclude, from the list or the range, the values of the parameters already applied for this user, notably on said terminal. This embodiment allows the repetition of the same trial on the same terminal for the same user to be blocked. Advantageously, each exclusion from the exclusion register is temporary.

Advantageously, in the case of a biometric access control system comprising several contact-based biometric dermatoglyph acquisition terminals, the set of characteristic values defining a set of luminous events to be applied to the dermatoglyph acquisition surface includes the identifier of the terminal that received said identification request.

The intensity control instructions for the at least one lighting source emitting in a first wavelength, so as to apply the first set of events during a first biometric acquisition step, are determined by the central unit 601 of the processing device 106 based on the values of the first set of characteristic values. If the values of the first set of characteristic values are determined locally by a central processing unit 601 of the processing device 106 of the biometric acquisition terminal 1, and the latter also comprises the control device, no remote transmission of these values is required; however, if the values of the first set of characteristic values are determined by a central processing unit housed in a remote device 101, i.e., outside the biometric acquisition terminal 1, said values are then transmitted via a communication network, and notably in a secure, preferably encrypted manner, to the control unit of the biometric acquisition terminal 1, made up of, for example, the printed circuit board (PCB) of the sensor of the terminal 1.

The security method P then continues with the control unit executing, step E2, the instructions for controlling the intensity of the at least one lighting source emitting in a first wavelength so as to apply the first set of events during a first biometric acquisition step. In the embodiment illustrated herein, the lighting source 5 is made up of a set of red light-emitting diodes and emits in a single wavelength, and the temporally variable control signal applies the first set of events, involving, for example, switching off the lighting source followed by switching on the lighting source at randomly selected application instants. The switching off instant is randomly selected between 0 and the exposure duration, and the switching on instant is randomly selected between the switching off instant and the exposure duration. The execution E2 of the instructions for controlling the intensity of the lighting source applies the pattern prescribed during the biometric acquisition step E3. Advantageously, provision can be made for any acquisition to begin with the emission of the lighting source 5 and, if the prescribed pattern does not provide for the lighting source to be switched off, a switching off command is applied at the end of the acquisition.

The execution, step E2, of the control instructions is implemented in conjunction with the biometric acquisition step E3 since, in the embodiment described herein, the instant 0 corresponds to the start of the biometric acquisition, i.e., to the start of the linear exposure of the acquisition surface by the rolling shutter over the vertical dimension during the predetermined exposure duration. In the embodiment illustrated herein, and in a non-limiting manner, the rolling shutter exposes line-by-line, and the raw signal emitted by the sensor is directly in the form of an acquisition matrix, also called raw image. Preferably, the raw signal emitted by the sensor is converted into an acquisition matrix. Similarly, in the case of a colour sensor, a dematrixing operation (conversion of the Bayer matrix into an RGB image) is preferably carried out on the raw data (signal originating from the sensor) before it is transmitted. The raw signal can also undergo minor transformation before transmission, notably transformation that does not affect subsequent computations. The exposure duration is very short and the finger of the user is assumed to remain stationary during acquisition, which lasts, for example, 60 ms. It should be noted that this assumption can be easily verified by finger detection algorithms.

The security method P then continues with the execution, step E4, by a characterization module of a central processing unit, in this case the data processing device 106 inside the terminal 1, of instructions for characterizing an observed lighting pattern, based on the acquisition matrix of the biometric acquisition. In an extreme case with image acquisition every 60 ms, corresponding to the total acquisition time, and an exposure duration of 30 ms for each pixel, i.e., half the acquisition time, a bright flash will not affect a few lines but all the lines, in varying proportions, and rather than detecting lines that are more or less bright (as is the case, for example, with an exposure duration that is less than one tenth of the acquisition time), the average brightness per line will gradually vary across the entire image. The characterization, step E4, of the observed lighting pattern is then based on the detection of variations in the average brightness MLI per line of the acquisition matrix obtained from the signal representing the acquired biometric feature, in other words, from the image acquired by the optical acquisition device. In a non-limiting manner, this characterization step E4 could result from the implementation of a neural network, notably a convolutional neural network, previously trained based on acquisition databases and observed patterns.

In this embodiment, with the lighting off, while having the estimate of the average brightness of each line MLI_ext based on the image acquired by the optical acquisition device during the presence detection phase, the average brightness of each line MLI_ext of the image acquired by the optical acquisition device during the presence detection phase is subtracted from the average brightness MLI per line based on the image acquired by the optical acquisition device during luminous variations. This subtraction removes light from the acquisition matrix that is not due to the lighting of the sensor.

Steps E1, E2, E3 and E4 can be repeated for a second set of events during a second acquisition, assuming that the finger is stationary.

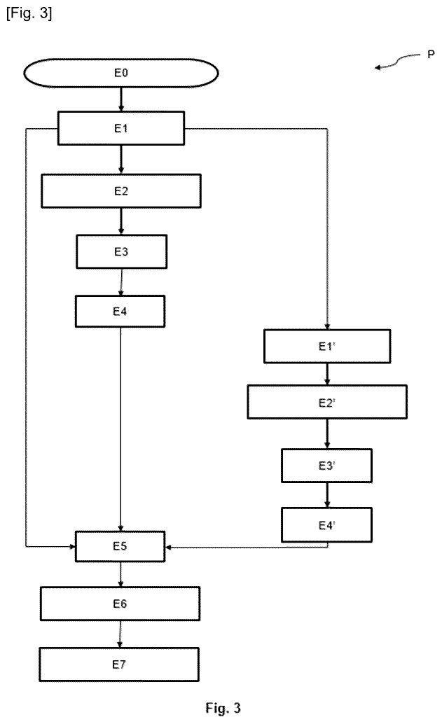

Once the one or more observed lighting patterns has/have been characterized, the method P continues by executing, step E5, by an evaluation module of a central processing unit, in this case, the data processing device 106 inside the terminal 1, instructions for evaluating a matching index, as explained hereafter with reference to FIG. 3. As a variant, the characterization, step E4, of the first pattern also can be latent and can underlie the step E5 of evaluating the matching index, notably if the latter is implemented by a neural network.

Once the matching index has been evaluated, the method continues by executing, step E6, by a judging module of a central processing unit, in this case, of the data processing device 106 inside the terminal 1, instructions for judging the presence or absence of fraud by comparing the matching index with a matching threshold in order to continue the method with a biometric enrolment step or a biometric authentication step if the matching threshold is met. Indeed, since by design the sensor is fairly insensitive to external light, any external disturbances are low; thus, if the one or more observed patterns do not match the one or more prescribed patterns, which is notably evaluated by comparing the computed matching rate with a threshold, the method is interrupted, notably with a warning being issued; otherwise, the method continues in this case with a biometric authentication step for the user. Biometric recognition (matching) of dermatoglyphs is carried out based on the acquired image and relative to biometric data (for example, in the form of a biometric template) enrolled and locally stored in a memory. In both cases, the time-stamped status, whether successful (no fraud) or unsuccessful (fraud detected), is preferably stored in a local RAM register or in an external register.

Several acquisitions can be made and analyzed one after the other according to the described method, for example for several dermatoglyphs, with the final judging step E6 then being common and based on the multiple computed matching indices. In other words, the two conditions must be met by which each matching index is compared with each matching threshold (or the same matching threshold) in order to continue the biometric authentication method, and a time-stamped status of no fraud is entered in the register linked to the security method, whereas, otherwise, the biometric authentication method is interrupted and a time-stamped status of fraud is entered in the register linked to the security method.

Intermediate data processing steps can be implemented before generating the enrolled biometric data or the biometric data to be authenticated, based on the acquired raw images, for example, by transforming them, notably before generating the reconstructed image of the biometric feature and/or the biometric template. The intermediate processing can involve one or more of the following image processing operators:
pixel-by-pixel (or point-by-point) modification operators. This involves, for example, colour, tint and gamma correction;
local operators, notably those for managing local blur or contrast, with a local operator relying on a pixel neighbourhood, i.e., more than one pixel but less than the entire image; a local operator allows an output pixel to be obtained from a neighbourhood of an input pixel;
operators in the frequency domain (after image transformation). The use of one or more operators in the frequency domain paves the way for various possibilities for analogue or digital noise reduction, such as reducing compression artefacts, improving image sharpness, crispness or contrast.

FIG. 3 illustrates a schematic diagram according to another embodiment of the method P. In the embodiment illustrated with reference to this figure, the steps of:
determining E1 the first set of characteristic values defining a first set of luminous events, notably including the computation of the theoretical average brightness MLT1 of each line of the first prescribed pattern,
controlling E2 the intensity of the lighting source so as to apply the first set of events during a first biometric acquisition step E3,
performing a first biometric acquisition E3, and
characterizing E4 a first observed lighting pattern and, notably, the average brightness MLI1 of each line of the acquisition matrix of the first acquisition,

are, for example, the same as those previously described with reference to FIG. 2. In this embodiment, the previously described steps are implemented again:
a step E1′ of determining a second set of characteristic values defining a second set of luminous events to be applied to an acquisition surface of the dermatoglyph, notably comprising computing the theoretical average luminosity MLT2 of each line of the second prescribed pattern. The second set of events describes a second lighting temporal sequence depicted as a matrix in the form of a second prescribed lighting pattern, with said values characterizing, for each event of the second set, a type of lighting for the acquisition surface and an application instant for said event, with at least one characteristic value per event, from among the lighting type and the application instant, being determined by random selection. This determination step E1′ in this case is shown after the step E4 of characterizing the first observed pattern, yet it also could be carried out as early as the step E1 of determining the first set of characteristic values, notably so as not to reproduce the same events from the first set of events; then
a step E2′ of controlling the intensity of at least one lighting source so as to apply the second set of events during a second biometric acquisition step; then
a step E3′ of carrying out a second biometric acquisition by linearly exposing the acquisition surface over the predetermined dimension for a predetermined exposure duration (in this case the same as the exposure duration applied during the first biometric acquisition E3) emitted in the form of an acquisition matrix;
a step E4′ of characterizing, based on the acquisition matrix of the second biometric acquisition E3′, a second observed lighting pattern and notably the average brightness MLI2 of each line of the acquisition matrix of the second acquisition.

Then, the step E5 of evaluating the matching index is equally dependent on the first and second observed patterns and the first and second prescribed patterns. For example, a CMLI ratio is computed for the patterns observed line-by-line, notably in the form of a vector, between the average brightness MLI2 of each line of the acquisition matrix of the second acquisition and the average brightness MLI1 of each line of the acquisition matrix of the first acquisition: such that CMLI=MLI2/MLI1 and a CMLT ratio is computed for the prescribed patterns line-by-line, notably in the form of a vector, between the theoretical brightness MLT2 of each line of the second prescribed pattern and the average theoretical brightness MLT1 of each line of the first prescribed pattern, such that: CMLT=MLT2/MLT1; these ratios correspond to multiplier coefficients. For example, if MLI1 =[1, 2, 3, 4, 5] and MLI2=[2, 4, 3, 4, 5], then CMLI=[2, 2, 1, 1, 1], and the same applies for computing CMLT. Preferably, in the event that lines have values close to 0, i.e., the lines are too dark, in order to avoid dividing by 0, these lines of the CMLI ratio of the observed patterns and, respectively, of the CMLT ratio of the prescribed patterns are ignored in the computation or are deleted, within a limit of n % (for example, 30 %) of the lines, with n being dependent on the sensor and knowing that a dark line corresponds to a line where the finger is not present. Then, the CMLI ratio of the observed patterns and the CMLT ratio of the prescribed patterns are compared, for example, by computing the p-norm of the vector V, such that V=CMLI−CMLT, in order to evaluate a non-matching index.

The step E6 of judging whether fraud is present or absent is then implemented by comparing the matching index with the non-matching threshold in order to continue the method with a biometric enrolment step or a biometric authentication step in the absence of fraud. If the preceding computation results in a positive number representing error, i.e., the non-matching index, and if this number is greater than the non-matching threshold, this indicates fraud, whereas the absence of fraud is indicated by a non-matching index strictly below the non-matching threshold. For example, for an average error of 5 % tolerated on the vector V relative to the average of CMLT (preferred to CMLI for reliability reasons), this would correspond, for a norm 1 (p=1), to a non-matching threshold value of 50 for an image with 1,000 lines (0.05×number of lines=50). It should be noted that the high p value for the p-norm will be detrimental to the extreme values, such as isolated errors. During this judging step E6, the results of the step are also recorded in the register, notably in the form of a fraud absence or presence status.

Advantageously, acquiring at least two images with lighting allows an additional step E7 to be implemented for reconstructing an image of the dermatoglyph based on the first and second acquisition matrices, notably by merging based on the consecutively acquired acquisition matrices. This reconstruction step E7 could, as a variant, be implemented during biometric authentication or enrolment. This reconstruction then improves the reliability and the performance capabilities of biometric recognition. Thus, when applying the method with a view to enrolling a user, the merging notably allows a complete image to be obtained without any altered areas (i.e., areas with less illumination). In one embodiment, if, during the reconstruction step E7, merging the common areas without alteration reveals discrepancies, due to movement of the fingerprint, for example, then steps E1 to E6 of the security method may need to be repeated. Once the image has been reconstructed, it can be supplied to biometric algorithms, for example, with a view to generating a template and being stored in a biometric enrolment database. Similarly, when the method is applied with a view to identification or authentication, then, from the first acquisition step E3, biometric algorithms can search for the presence of characteristic points with sufficient quality and at a sufficient distance from the altered areas in order to find a reliable match. If the reliability is insufficient (for example, number of characteristic points below a predetermined threshold), several acquired images can be merged until a match is obtained with sufficient reliability.

It should be noted that the prescribed lighting pattern is random and that, once the relevant image has been acquired, the computations can be carried out at a later stage, notably remotely, so that steps E4, E5 and E7 can be carried out at any time after steps E1/E2/E3, either locally or remotely.

As a variant, the exposure duration of the second biometric acquisition E3′ can be different from the exposure duration of the first biometric acquisition E3; since these values are known to the system, their ratio will then be taken into account in step E5 of evaluating the matching index.

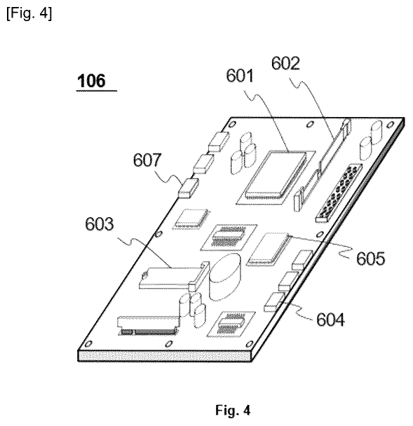

FIG. 4 shows an example of the structure of a data processing device 106 for implementing one or more embodiments of the invention. The data processing device 106 typically comprises one or more central processing units (CPUs) 601 and/or one or more graphics processing units (GPUs) 605, a physical communication module (NET) 604, one or more physical input/output modules 607 for exchanging data with external devices (such as the optical acquisition device) (communication bus, not shown), a transient storage medium 602, such as random access memory (RAM), a non-transient storage medium 603 (FLASH), and communication buses (not shown) for transferring data between the internal components of the data processing device 106.

The data processing device 106 allows one or more program modules to be executed that comprise instructions which, when the one or more program modules is/are executed, cause the data processing device 106 to implement the method according to the invention. The one or more program modules can be written in any programming language, compiled or interpreted. They can form part of a software solution, i.e., a collection of executable instructions, codes, scripts or the like and/or databases.

The data processing device 106 comprises the following elements, connected to each other via a communication bus:
a central processing unit (CPU) 601, such as a microprocessor, and notably including a high-precision internal clock used to: record the precise time when the sensor returns from the end of transmission of the previous image and executes each change at the scheduled instant. Similarly, a TRNG (True Random Number Generator) that draws the random values is included in the CPU 601;
a transient memory 602 for storing the executable code of the method of the invention, as well as the registers adapted to record variables and parameters necessary for implementing the method according to embodiments of the invention; the memory capacity of the device is preferably supplemented by an optional random access memory 602 connected to an expansion port, for example;
a non-transient memory 603 for storing computer programs and calibration data for implementing embodiments of the invention; the stored computer programs notably include a computer program comprising instructions adapted for implementing all or some of the steps of the method according to the invention when said program is executed on the processing device 106, said non-transient memory 603 is then an example of a non-transient, removable or non-removable information storage means;
a communication module 604 comprising a network interface 604 is connected to a communication network, over which digital data to be processed is transmitted or received; the network interface 604 can be a single network interface, or can made up of a set of different network interfaces (for example, wired and wireless interfaces or different types of wired or wireless interfaces). Data packets are sent over the network interface for transmission or are read from the network interface for reception under the control of the software application running in the processor 601;
a user HMI interface, notably comprising a graphics processor 605, for receiving inputs from a user or for displaying information to a user, notably guidance information (visual and/or voice);
an input/output module 607 for receiving/sending data from/to external peripheral devices such as a hard disk, a removable storage medium or the like.

The executable code can be stored in the non-transient memory 603, for example a flash memory or a read-only memory, or on a removable digital medium, such as a disk, for example. According to a variant, the executable code of the programs can be received by means of a communication network, via the network interface 604, in order to be stored in one of the storage means of the data processing device 106, such as the memory 603, before being executed.

The central processing unit 601 is adapted to control and direct the execution of instructions or portions of software code of the program or programs according to one of the embodiments of the invention, which instructions are stored in one of the aforementioned storage means, such as the non-transient memory 603. After powering-up, the CPU 601 is capable of executing instructions from the non-transient RAM 602 relating to a software application. Such software, when it is executed by the processor 601, allows the method according to the invention to be executed.

In one embodiment, the device is a programmable device that uses software to implement the invention. As a variant, the present invention can be implemented in the hardware (for example, in the form of a specific integrated circuit or ASIC (application-specific integrated circuit) or in the form of a programmable logic component or FPGA (field programmable gate array)).

According to one embodiment, the data processing device 106 is only locally housed in the biometric acquisition terminal 1, which is, for example, the preferred architecture in the case of a fixed terminal, for example a fixed terminal dedicated to identity checks. As a variant, the information processing device 106 can be outside the terminal 1, or can be distributed and can comprise multiple processing sub-units, notably at least some of which are outside the terminal 1 and communicate with each other via the network interface 604. Similarly, notably depending on the nature of the terminal, all or part of the memory can be physically remote, hosted, for example, on a remote server 101. For example, notably for a fixed terminal 1, the terminal is the master and the initialization, acquisition and control modules are locally hosted in the terminal 1, but the other modules may not be, or may only be partially, locally hosted but are hosted in a physically remote slave processing entity, such as a remote server 101; this sharing of computations between the local terminal 1 and the remote server means that only the information necessary for decision-making is sent to the remote server 101, thereby minimising the response time associated with exchanging data and network throughput, without compromising client related security linked to reverse engineering. Redundant computations are also possible, with the remote server checking all or some of the tasks completed by the terminal 1. As a variant, the remote server 101 is the master and the user terminal 1 is the slave, so that the random selection is executed by the remote server, and then the prescribed pattern is transmitted in real time by the remote server 101 to the terminal 1 so that said terminal implements the control while being “agnostic” with respect to the randomly selected values characterizing the trial, which maximizes the security of the terminal 1 and prevents replay on the user terminal side, as said terminal does not unilaterally decide upon the trial. Similarly, the terminal 1 can then send the acquired raw encrypted signals directly to the remote server 101 in order to minimize the local computations and reduce the risks associated with reverse engineering, or, conversely, can directly transmit the information necessary for decision-making (for example, the matching index) in order to minimize the network load and the response time associated with exchanging data and dependent on network throughput. Preferably, the exchanged information, notably from the remote server 101 to the terminal 1, is encrypted to improve the security of the exchanges.

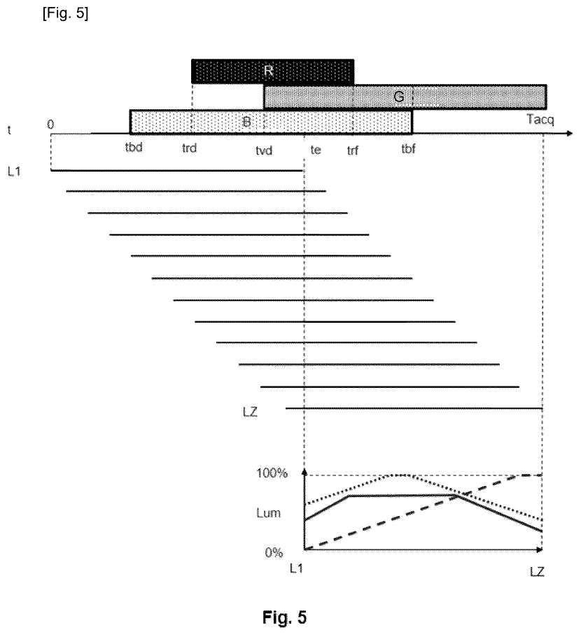

The simplified example in FIG. 5 illustrates the temporal sequence for applying, in the time t, a first set of luminous events, in this case comprising three events defined as:
lighting B with a blue wavelength, by a blue light-emitting diode, starting at the instant tbd and ending at the instant tbf;
lighting G with a green wavelength, using a green light-emitting diode, starting at the instant tvd and ending at the instant tvf;
lighting R with a red wavelength, using a red light-emitting diode, starting at the instant trd and ending at the instant trf.

In this embodiment, only the light-emitting diodes of an additional RGB lighting source for red, green and blue lighting are used, but the main lighting source for red light-emitting diodes (backlight) also could be used in combination.

In the illustrated example, the time t equal to 0 corresponds to the start of exposure of the first row in the predetermined dimension, in this case, line 1 L1, of the acquisition matrix; the exposure time is 30 ms for a total acquisition duration Tacq of 60 ms, that is, an acquisition frequency of 15 images per second (fps), which means that each of the lines from L1 to LZ will be exposed for 30 ms, that is, half an acquisition period. The first line L1 finishes exposing at the and at the same instant its line vector is sent over the communication bus between the optical acquisition device and the data processing device 106, and so on for the following lines until the last line LZ, whose exposure ends at the same time as the end of the acquisition Tacq. In this embodiment, an RGB sensor is used, which means that 15 images per second are acquired for each R, G, B channel.

The graph below the lines represents the average brightness Lum per colour channel and per line upon reception on the bus, with the blue channel (for example, between 455 and 465 nm) being represented by a line of closely spaced apart dashes, the green channel (for example, between 515 and 525 nm) being represented by a line of widely spaced apart dashes, and the red channel (for example, between 620 and 630 nm) being represented by a solid line. This representation in the form of a matrix illustrates the average brightness of each line MLI of the observed pattern. Indeed, the useful information is made up of an average brightness Lum value per line, and in this case per colour channel since an RGB colour sensor is used, and these average brightness Lum values are computed based on the acquisition matrix. The graph as illustrated represents the case of a uniform image (sensor illuminated uniformly, notably without a finger placed on it) for the sake of clarity. Indeed, when a finger is placed on the sensor, the graph changes, yet this does not affect the computations because two successive images are compared, with the finger remaining stationary.

The evaluation of matching patterns is based on the fact that the sensor is of the rolling shutter type, with the lines being exposed one after the other in a predictable manner. Similarly, the duration between the end of the transmission of an image and the start of exposure of the first line of the sensor, as well as the duration between two successive line exposures, are known in advance and are predetermined by the timing settings of the sensor, with all these durations being accurate to the nearest microsecond and being measured by the high-precision internal clock. The high-precision internal clock of the CPU 601 therefore allows the time between the lighting modification instants and the end of transmission of the image to be measured accurately. Thus, any minor change in the intensity of the main lighting source results in an average change in brightness A starting at the line L. Since A is known and L can be deduced from the duration between the end of reception of the previous image and the instant when the lighting modification was controlled, the theoretical average brightness MLT prescribed per line can be determined in order to compare it with the average brightness MLI observed per line based on the image acquired by the optical acquisition device and it is thus possible to verify whether the received image contains proof of the trial. Similarly, any brief interruption of the main lighting source will result in the presence of N underexposed lines from the line L, where N and L can be precisely computed, meaning it is possible to verify whether the received image contains proof of this change. Similarly, any brief illumination of a red, green or blue LED of the auxiliary RGB lighting source with a colour C results in N lines overexposed in the colour C, starting from the line L. Since C is known and N and L can be deduced from the duration between the end of reception of the previous image and the instant at which said changes were made, it is possible to check whether the received image contains proof of these changes.

Advantageously, the security method P comprises an additional terminal control phase, prior to the initialisation step, notably upon start-up of the terminal 1 or recurring and/or occurring at regular intervals when the terminal 1 is on standby, implementing steps E1 to E5 of the method according to the invention (without a finger) and if the obtained matching index is below a predetermined control threshold (preferably equal to the matching threshold, or is slightly lower in order to increase tolerance), then unexpected alterations are considered to have occurred, indicating a malfunction in the terminal, and one or more of the following actions can be carried out: issuing a warning, locking the product, returning the terminal to factory settings. This additional control phase is particularly useful for optical acquisition devices in which part of the acquisition surface, called the working area, enjoys total or near-total reflection, with the sensor having a wider field that is not restricted to this working area.

In one embodiment in which the optical acquisition device of the terminal 1 is not RGB colour but is monochrome, the sensor then acquires a single image, in greyscale, for example, during each acquisition period, but remains capable of detecting changes in brightness, and precise calibration of the intensity allows the colour of overexposed lines to be differentiated, notably by means of coloured markers on the optical acquisition device disposed in the acquisition field of the sensor outside the working area.

The invention therefore allows the biometric acquisitions to be secured, notably by monitoring the link between the contact-based biometric sensor and the data processing device 106 (local or remote) that receives and processes the data acquired by the sensor with a view to enrolment or authentication.

1. A method for secure contact-based acquisition of a biometric feature of a user, comprising:
determining a first set of characteristic values defining a first set of luminous events to be applied to an acquisition surface for the biometric feature, said first set of events describing a first lighting temporal sequence depicted as a matrix in the form of a first prescribed lighting pattern, said values characterizing, for each event of the first set, a lighting type for acquisition surface and an application instant for said event, with at least one characteristic value per event, from among the application instant and the lighting type, being determined by random selection;
controlling the intensity of at least one lighting source, emitting in a first wavelength, so as to apply the first set of events during a first biometric acquisition;
carrying out a first biometric acquisition by linearly exposing the acquisition surface over a predetermined dimension for a predetermined exposure time, emitted in the form of an acquisition matrix;
characterizing, based on the acquisition matrix of the first biometric acquisition, a first observed lighting pattern;
evaluating a matching index based on the first observed pattern and the first prescribed pattern; and
judging the presence or absence of fraud by comparing the matching index with a matching threshold in order to continue the method with a biometric enrolment or a biometric authentication if the matching threshold is met.

2. The method according to claim 1, wherein evaluating a matching index involves comparing the first observed pattern with the first prescribed pattern, with the matching index depending on a ratio between the first observed pattern and the first prescribed pattern.

3. The method according to claim 1, further comprising:
determining a second set of characteristic values defining a second set of luminous events to be applied to the acquisition surface, said second set of events describing a second lighting temporal sequence depicted as a matrix in the form of a second prescribed lighting pattern, said values characterizing, for each event of the second set, a lighting type for the acquisition surface and an application instant for said event, with at least one characteristic value per event, from among the application instant and the lighting type, being determined by random selection;
controlling the intensity of the lighting source so as to apply the second set of events during a second biometric acquisition;
carrying out a second biometric acquisition by linearly exposing the acquisition surface over a predetermined dimension for a predetermined exposure time that is equal to or different from the predetermined exposure time, emitted in the form of an acquisition matrix;
characterizing, based on the acquisition matrix of the second biometric acquisition, a second observed lighting pattern; and
evaluating the matching index based on the second observed pattern and the second prescribed pattern.

4. The method according to claim 3, wherein evaluating a matching index involves comparing observed patterns with the prescribed patterns, with the matching index depending on a ratio between the first observed pattern and the second observed pattern, divided by a ratio between the first prescribed pattern and the second prescribed pattern.

5. The method according to claim 3, further comprising reconstructing an image of the biometric feature from the first and second acquisition matrices by merging from said acquisition matrices.

6. The method according to claim 1, wherein the biometric feature is a finger or palm dermatoglyph.

7. The method according to claim 1, wherein the value characterizing the event application instant designates a row of the prescribed lighting pattern depicted as a matrix.

8. The method according to claim 1, wherein the value of the lighting type designates a prescribed lighting state, or a modification of lighting from among a modulation of the intensity of the lighting by the lighting source, the switching off of the lighting source or the switching on of the lighting source.

9. The method according to claim 1, wherein said application instants of each event of the first or second acquisition are defined relative to the start of exposure, specific to said acquisition, of the first row in the predetermined dimension of the acquisition matrix.

10. The method according to claim 8, wherein the value of the lighting type designates the prescribed lighting state, with said application instants of each event of the first or second acquisition characterizing the start instant of the application of the prescribed lighting state specific to said event.

11. The method according to claim 10, wherein at least one of the sets of determined characteristic values contains, for at least one of the events, a value characterizing the end of the application of the prescribed lighting state specific to said event.

12. The method according to claim 1, wherein each prescribed pattern is expressed as a theoretical average brightness of each row of its acquisition matrix, with each prescribed pattern being determined based on its characterizing lighting temporal sequence and the predetermined exposure time of the acquisition matrix.

13. The method according to claim 1, wherein characterizing the observed pattern is carried out, for each biometric acquisition, by:
computing an average brightness per channel of monochrome, red, green or blue, of each row of the acquisition matrix in the predetermined dimension.

14. A biometric access control system comprising:
a terminal for contact-based acquisition of a biometric feature, said terminal comprising:
a contact-based optical acquisition device comprising a sensor, an acquisition surface configured to be in contact with the biometric feature, and a rolling shutter configured to linearly expose the acquisition surface over a predetermined dimension for a predetermined exposure time, with said optical acquisition device being configured to transmit a signal representing the acquired biometric feature in the form of an acquisition matrix;
a lighting source emitting in a first wavelength and disposed behind the acquisition surface and emitting towards the acquisition surface;
an intensity control device for at least one lighting source emitting in a first wavelength so as to apply the first set of events during a first biometric acquisition; and
a communication bus between the optical acquisition device and a data processing device
the data processing device comprising:
a module for determining a first set of characteristic values defining a first set of luminous events to be applied to an acquisition surface for the biometric feature, said first set of events describing a first lighting temporal sequence depicted as a matrix in the form of a first prescribed lighting pattern, said values characterizing, for each event of the first set, a lighting type for the acquisition surface and an application instant for said event, with at least one characteristic value per event, from among the application instant and the lighting type, being determined by random selection;
a module for characterizing an observed lighting pattern of said acquisition matrix; and
a module for evaluating a matching index based on the observed pattern and the prescribed pattern and for judging the presence or absence of fraud.

15. The system according to claim 14, wherein the data processing device includes:
a memory, storing enrolled biometric data in the form of a template; and
a biometric recognition module based on the first biometric acquisition or on a reconstructed image of the biometric feature and the enrolled biometric data.

16. The method according to claim 2, further comprising:
determining a second set of characteristic values defining a second set of luminous events to be applied to the acquisition surface, said second set of events describing a second lighting temporal sequence depicted as a matrix in the form of a second prescribed lighting pattern, said values characterizing, for each event of the second set, a lighting type for the acquisition surface and an application instant for said event, with at least one characteristic value per event, from among the application instant and the lighting type, being determined by random selection;
controlling the intensity of the lighting source so as to apply the second set of events during a second biometric acquisition;
carrying out a second biometric acquisition by linearly exposing the acquisition surface over a predetermined dimension for a predetermined exposure time that is equal to or different from the predetermined exposure time, emitted in the form of an acquisition matrix;
characterizing, based on the acquisition matrix of the second biometric acquisition, a second observed lighting pattern; and
evaluating the matching index based on the second observed pattern and the second prescribed pattern.

17. The method according to claim 2, wherein the value of the lighting type designates a prescribed lighting state, or a modification of lighting from among a modulation of the intensity of the lighting by the lighting source, the switching off of the lighting source or the switching on of the lighting source.

18. The method according to claim 3, wherein the value of the lighting type designates a prescribed lighting state, or a modification of lighting from among a modulation of the intensity of the lighting by the lighting source, the switching off of the lighting source or the switching on of the lighting source.

19. The method according to claim 2, wherein said application instants of each event of the first or second acquisition are defined relative to the start of exposure, specific to said acquisition, of the first row in the predetermined dimension of the acquisition matrix.

20. The method according to claim 3, wherein said application instants of each event of the first or second acquisition are defined relative to the start of exposure, specific to said acquisition, of the first row in the predetermined dimension of the acquisition matrix.
